(19) United States
(12) Patent Application Publication
(10) Pub. No.: US 2005/0153825 A1
(43) Pub. Date: Jul. 14, 2005

(54) Ceramic composite material, method for the production thereof, and pencil-type glow plug containing such a composite material

(76) Inventors: Ralf Riedel, Stuttgart (DE); Alexander Klonczynski, Ludwigsburg (DE); Wolfgang Dressler, Vaihingen/Enz (DE)

Correspondence Address: KENYON & KENYON, ONE BROADWAY, NEW YORK, NY, 10004, US

(21) Appl. No.: 10/503,314

(22) PCT Filed: Dec. 16, 2002
(86) PCT No.: PCT/DE02/04584

(30) Foreign Application Priority Data
Jan. 30, 2002 (DE) 102 03 714.0
Sep. 17, 2002 (DE) 102 43 017.9

(51) Int. Cl. C04B 35/571

(52) U.S. Cl. 501/88; 501/92

(57) ABSTRACT

A ceramic composite material is described, which is obtainable by at least partial pyrolysis of a starting mixture or of a starting body containing a polymer precursor material. The starting mixture or the starting body contains boron in a proportion of 0.1 wt.-% to 60 wt.-%. In addition, a method for manufacturing such a ceramic composite material is described, a boron-containing starting mixture including a polymer precursor material being subjected to an at least partial pyrolysis. Finally, a sheathed-element glow plug including the ceramic composite material as an insulating layer and/or conductive layer is described.

### FIELD OF THE INVENTION

The present invention relates to a ceramic composite material, a method for manufacturing it and a sheathed-element glow plug containing such a composite material.

### BACKGROUND INFORMATION

In the manufacture of ceramic sheathed-element glow plugs, such as those described in German Published Patent Application Nos. 198 52 785 or 100 20 329, ceramic composite materials, in particular amorphous Si—O—C ceramics may be used, which are obtained through the partial pyrolysis of organoelement precursors. The precursor thermolysis method as compared to other manufacturing methods for ceramics, i.e., sintering, may involve a substantially lower process temperature and a simple working properties and moldability of polysiloxane resins. The procedure is also described in German Published Patent Application No. 195 38 695.

Furthermore, to manufacture molded articles from these ceramic composite materials additional fillers may be required because otherwise contraction cracks and pores may occur during the pyrolysis. To that end, European Published Patent Application No. 0 412 428 describes the use of selected fillers in a starting composite to adjust the properties of the ceramic composite material obtained such as its coefficient of thermal expansion, thermal conductivity or electrical resistivity. In particular, the use of reactive fillers to obtain improved bonding of the fillers to the matrix or even the use of inert fillers was described in that patent.

### SUMMARY OF THE INVENTION

An exemplary embodiment and/or exemplary method of the present invention may provide a ceramic composite material, which is usable in a sheathed-element glow plug, having an increased electrical resistivity, which should be as independent as possible from fillers added to the composite material, as well as having a longer service life. In addition, the ceramic composite material should have no or as little as possible aging of its functional properties when used in a sheathed-element glow plug, in particular, for example, with respect to heating time and glow temperature.

The incorporation of 0.1 wt.-% to 60 wt.-% boron, such as, for example, 0.5 wt.-% to 10 wt.-% boron, into a polymer matrix and/or the use of appropriate, such as, for example, small quantities of boron-containing fillers in the manufacture of ceramic composite materials, such as, for example, amorphous Si—O—C ceramic composite materials, may inhibit the phase separation in the Si—O—C matrix and accordingly may inhibit the formation of free carbon, which may increase the electrical resistivity of the ceramic composite material, initially independently of additionally used fillers. Even after an extended aging at ambient temperature, for 100 hours, for example, no relevant aging of the electrical resistivity was determined, for example, in an insulation layer manufactured in this manner for a sheathed-element glow plug.

Furthermore, improved vitrification may be achieved in the ceramic composite material, which is believed to be at least partially attributable to the formation of boron-containing glasses or corresponding glass-like regions in the composite material having a reduced glass transition temperature, and which may increase the service life of sheathed-element glow plugs manufactured from it.

In particular, a dense glass layer may now be formed in and/or on the surface of the composite material, and an oxidation in the interior of the material used may not occur even after extended aging times, for example, 100 hours, i.e., no MoO₃, Mo₅Si₃ or crystalline SiO₂ forms, for example, which should facilitate self-healing processes in the material in the event of crack formation and increas its strength overall.

Furthermore, even the addition of comparatively low quantities of boron at 1300° C. for 100 hours or at 1350° C. for 8 hours in air may suppress the occurrence of crystallization of a ceramic matrix based on formation of Si—O—C with the formation of cristobalite, which should also increase the service life and resistance to alternating thermal stress of the material

In summary, the boron used may suppress aging of the electrical resistivity in the ceramic composite material and improve its functional properties and accordingly also those of a sheathed-element glow plug manufactured from it with respect, for example, to heat-up time and glow temperature.

When the composite material to be manufactured is used in a sheathed-element glow plug, it may be furthermore found that this increases the electrical resistivity of the insulation layer of the sheathed-element glow plug, suppresses undesirable aging of the resistance of the insulation layer and/or the conductive layer of the sheathed-element glow plug and may result in a narrower resistance distribution in the conductive layer, which, among other things, should result in reduced expense in manufacturing, in quality control and resistance classification. Furthermore, the insulation layer of the sheathed-element glow plug may be made thinner as a whole.

### BRIEF DESCRIPTION OF THE DRAWINGS

FIG. 1 shows the difference in the percentage pyrolytic contraction of a boron-containing ceramic composite material compared to a boron-free material as a function of the pyrolysis temperature.

FIG. 2 shows a Raman spectrum of the boron-containing and of the boron-free composite material according to FIG. 1 at a temperature of 1325° C.

FIG. 3 shows the electrical resistivity of a boron-containing composite material as a function of aging time in air at 1300° C. aging temperature.

FIG. 4 shows dilatometric measurements to determine the thermal coefficient of expansion in a boron-containing composite material compared to a boron-free material as a function of aging time in air at 1300° C. aging temperature.

### DETAILED DESCRIPTION

In the “Rapitherm” ceramic sheathed-element glow plug developed by Robert Bosch GmbH, as described in German Published Patent Application Nos. 100 20 329 and 195 38 695 A1, a ceramic composite material from a precursor ceramic is used, which was subjected, for example, to partial pyrolysis at a temperature of, for example, 600° C. to 1400° C., in particular 1200° C. to 1300° C. The starting material is a polysiloxane, i.e., an Si, C, O and H polymer, which is mixed with fillers such as MoSi₂, SiC, Al₂O₃, TiC, B₄C, BN, TiN, mullite, or Fe.

The selection of the fillers, as described in greater detail in German Published Patent Application No. 195 38 695, may provide a tailoring the electrical and physical properties profile of the ceramic composite material of the sheathed-element glow plugs resulting after the pyrolysis to the particular requirement profile.

The use of an oxygen-containing polysiloxane precursor as a starting material also may allow simple processing in air and thus products may be manufactured cost effectively. Moreover, a pyrolysis product of this type or a ceramic composite material of this type from a filled polysiloxane may have desirable strength properties, high chemical stability against oxidation or corrosion and may not be harmful to health.

One of the desired features of the precursor thermolysis method according to German Published Patent Application No. 195 38 695 compared to other manufacturing methods for ceramic composite materials, such as sintering, is that a significantly greater range of possible fillers may be available because the pyrolysis takes place at significantly lower temperatures compared to sintering at temperatures of typically more than 1600° C. (in the case of Si₃N₄ in particular). Thus, fillers may still be used in this precursor pyrolysis process that are liquid or volatile at customary, comparatively high sintering temperatures, and phase reactions that otherwise occur at higher temperatures are also avoided. Finally, polysiloxane resins as meltable thermosetting polymers or precursors, which are soluble in organic solvents, may allow filler to be incorporated simply and homogeneously, by kneading or dissolving, for example.

To set a desired property of the material created using the filler simply and effectively, the influence of the matrix on the particular property should first be as low as possible. Since the matrix in ceramic composite materials such as those used for ceramic sheathed-element glow plugs forms a contiguous network, in the case of, for example, an insulating intermediate layer in a sheathed-element glow plug to be manufactured from this material, the matrix may have too low an electrical resistivity after the manufacturing process is completed, or the matrix or the entire composite material may gradually lose its high-temperature resistance and thermal shock strength due to phase transitions, crystallization effects and oxidation processes during manufacturing or later in use.

According to an exemplary embodiment and/or exemplary method of the present invention, boron is used in a mixture or in a starting body according to German Published Patent Application No. 195 38 695 or the addition of boron to a polymer material or precursor material such as a polysiloxane resin and/or the modification of the polymer or precursor material by boron, a ceramic composite material, such as, for example, an amorphous Si—O—C ceramic matrix, including or not including a filler then being produced via a precursor thermolysis method in connection with, for example, a partial pyrolysis.

The modification of the polymer or precursor material by boron, for example, in the form of boric acid esters and/or the addition of boron, for example, as an additive in the form of one or a plurality of boron-containing fillers such as elementary boron, B₂O₃, BN or B₄C should result first in an improved high-temperature resistance of the material with respect to phase separation and crystallization properties. Furthermore, the service life of the material obtained should be improved and the aging of the electrical resistivity should be reduced.

In addition, the explained use of boron should result in a significant and desired increase in the electrical resistivity of an ordinary ceramic composite material known, for example from German Published Patent Application No. 195 38 695, such as is used, for example, as an insulating layer in sheathed-element glow plugs. It was thus observed that addition of boron at room temperature increases the electrical resistivity of the insulating layer of such a sheathed-element glow plug manufactured from a ceramic composite material via a precursor thermolysis method by a factor of 1000.

The use of boron may cause the resistivity of the insulation layer of the sheathed-element glow plug to be stabilized in a range higher than 10000 ohm•cm without the necessity of a significant change in the compound composition of the insulating layer. On the other hand, an insulating layer resistance of this type may be a prerequisite for the manufacture of a sheathed-element glow plug having a reduced shaft diameter.

Boron-containing ceramic composite materials may be produced, which have been obtained either by the addition of boron-containing fillers to a polysiloxane or by modification of the corresponding polymer precursor and subsequent pyrolysis in a gas atmosphere adapted to the application at a temperature ranging between 600° C. and 1400° C., such as, for example, 1100° C. to 1300° C. In particular, boron-containing additives such as B₂O₃ were incorporated in insulating compounds and conductive compounds discussed, for example, in German Published Patent Application No. 105 38 695, for sheathed-element glow plugs during the preparation of boron-containing additives, and subsequently, the pyrolysis was performed in the usual manner.

### EXAMPLE 1

Two compounds are produced, for example, according to German Published Patent Application No. 195 38 695 having an identical volume fraction of fillers, one of them containing 75 vol.-% polymer (polysiloxane resin) and 25 vol.-% SiO₂ and the other containing 75 vol.-% polymer (polysiloxane resin) and 35 vol.-% of a SiO₂/B₂O₃ mixture. The SiO₂/B₂O₃ mixture contains 80 wt.-% SiO₂ and 20 wt.-% boron or B₂O₃.

The compounds are prepared by grinding the relevant starting powder, subsequent screening using a 150 μm mesh size, followed by cross-linking and molding via hot pressing.

Subsequently, the samples are pyrolyzed into compact samples at a heat-up time of 25 K/h to a final temperature of 1300° C.

In the pyrolysis to a final temperature of 1300° C., the sample containing no boron displayed a shrinkage in length Δ1/1 of −16.5%, a loss of mass Δm/m of −17.0% and an electrical resistivity of approximately 10⁵ Ω•cm while the boron-containing sample had a shrinkage in length Δ1/1 of −15.3%, a loss of mass Δm/m of −18.0% and an electrical resistivity of more than 10⁶ Ω•cm.

In order to study the different stages of ceramization of the material, the pyrolysis was interrupted at different temperatures as part of a test series.

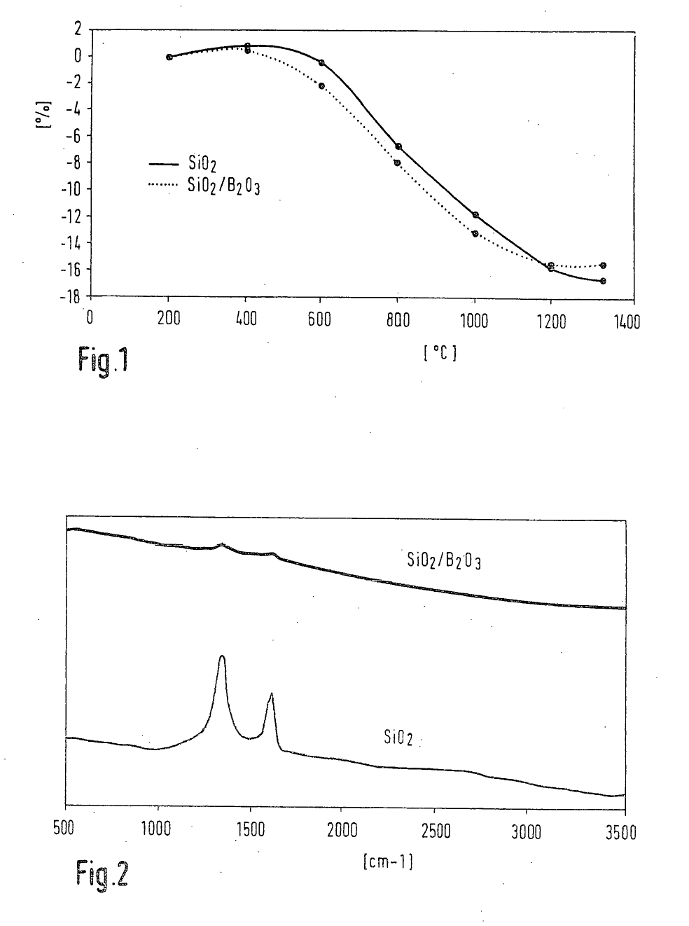

In that regard, FIG. 1 shows a comparison of the shrinkage curve of the SiO₂-containing sample and the SiO₂/B₂O₃-containing sample, it being evident that the addition of boron results in a shrinkage already occurring at relatively low temperatures, which might be prompted by formation of a borosilicate-like glass, which reduces the glass transition temperature, and/or by the action of boron as a sintering aid.

The Raman studies of the carbon bands on samples that were pyrolyzed at 1325° C. shown as examples in FIG. 2 provided further evidence that, compared to the boron-free sample, the phase separation in the boron-containing sample is inhibited initially and only occurs at substantially higher temperatures.

Since the separation of carbon in the samples, i.e., the ceramic composite materials produced, is seen as a reason for their in particular gradual reduction of electrical resistivity, a correlation to the Raman studies according to FIG. 2 may be provided by measuring the electrical resistivity. It was shown that the samples that displayed marked phase separations in the Raman spectrum have comparatively lower electrical resistivity values.

### EXAMPLE 2

Again, based on the teaching of German Published Patent Application Nos. 195 38 695 or 100 20 392, boron-containing insulation compounds are produced for a ceramic sheathed-element glow plug, which are prepared, starting with appropriate ceramic starting mixtures, using a mixing and kneading process, followed by molding using transfer molding.

The composition of the different ceramic starting mixtures produced is within the ranges 50 to 80 vol.-% polysiloxane (including an addition of 1 wt.-% zirconium acetylacetonate, which is used as a catalyst for the cross-linking of the polysiloxane, e.g., in hot pressing), 0 to 10 vol.-% SiC as a filler, 0 to 20 vol.-% Al₂O₃ as a filler, 0 to 20 mol.-% MoSi₂ as a filler and 3 wt.-% boron, which is used in the form of B₂O₃. In addition, a corresponding boron-free reference sample was produced for each of the samples having varying composition within these ranges.

After molding, the pyrolysis was performed at temperatures of 1300° C. in a circulating argon atmosphere in an Astro graphite oven. Subsequently, the samples, i.e., ceramic composite materials produced, were aged in air for 13 hours at 1300° C. in a Nabertherm oven.

The boron-containing samples displayed a comparatively high shrinkage in length Δ1/1 of approximately −9.8%, a loss of mass Δm/m of approximately −4.7% and an electrical resistivity of more than 10⁶ Ω•cm after pyrolysis and aging, while the boron-free reference samples displayed a shrinkage Δ1/1 of only approximately −8.9%, a loss of mass Δm/m of approximately −4.5% and an electrical resistivity of 10⁴ Ω•cm after pyrolysis and aging.

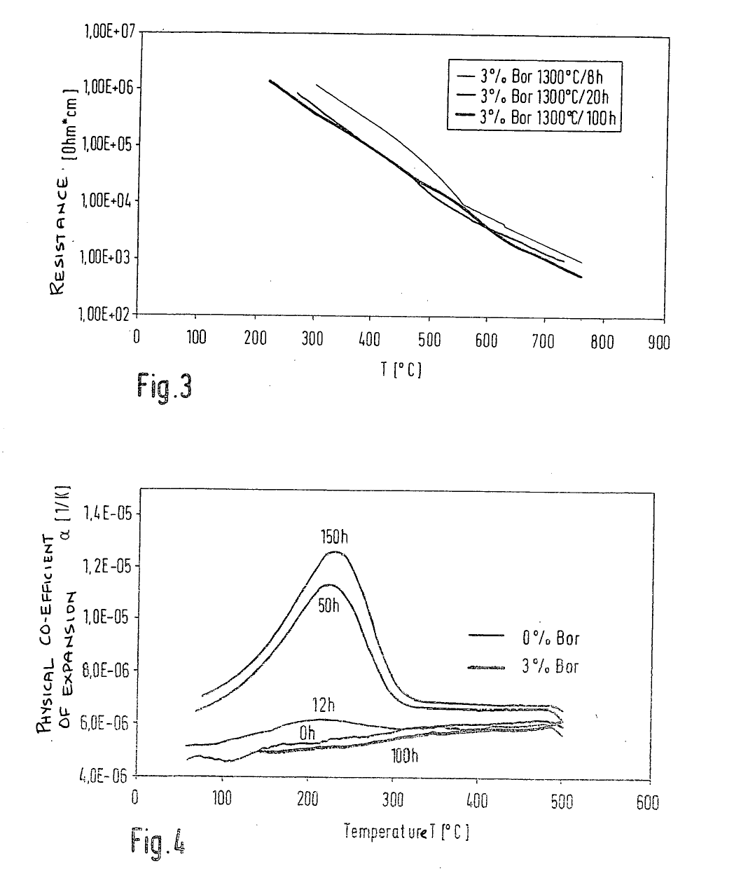

In order to verify that the addition of boron improves the resistance aging of the insulating layer, additional temperature-dependent measurements of the electrical resistivity were taken after various aging times, which are shown in FIG. 3 as examples. Specifically, FIG. 3 shows the temperature-dependent electrical resistivity of one of the insulation compounds explained above including an additive in the proportion of 3 wt.-% boron in the form of elementary boron after 8 hours, 20 hours, and 100 hours of aging time in air at 1300° C.

Finally, the crystallization with respect to cristobalite development as a function of aging time in air at 1300° C. was studied in these samples. To that end, FIG. 4 shows a dilatometric measurement of the thermal coefficient of expansion as a function of temperature for a sample containing a boron additive according to FIG. 3, i.e., having 3 wt.-% boron, which was previously aged in air at 1300° C., as well as corresponding measurements of samples without a boron additive, which had previously been aged in air at 1300° C. for 0 hours, 12 hours, 50 hours or 150 hours. The measurements of FIG. 4 were taken at a heat-up rate of 5 K/min in an argon atmosphere.

Aging of the boron-containing sample has no effect on the thermal expansion properties, while in the boron-free sample, serious changes occur even after 12 hours and in particular, after 50 hours of aging time in the temperature range of approximately 220° C., which may be attributable to the onset of crystallization with the formation of cristobalite.

1-8. (canceled)

9. A ceramic composite material, comprising:
a material formed by at least partial pyrolysis of one of a starting mixture and a starting body containing a polymer precursor material, wherein the starting mixture or starting body includes boron in a proportion of 0.1 wt.-% to 60 wt.-%.

10. The ceramic composite material of claim 9, further comprising:
a matrix, which is at least largely composed of an amorphous Si—O—C ceramic.

11. The ceramic composite material of claim 9, further comprising:
at least one filler.

12. The ceramic composite material of claim 9, wherein the at least one filler is one of Al₂O₃, SiO₂, TiO₂, ZrO₂, SiC and MoSi₂.

13. The ceramic composite material of claim 9, wherein the polymer precursor material includes a polysiloxane precursor.

14. The ceramic composite material of claim 9, wherein the one of the starting mixture and the starting body includes boron in a proportion of 0.5 wt.-% to 10 wt.-%.

15. The ceramic composite material of claim 9, wherein the one of the starting mixture and the starting body includes at least one of polysiloxane and a boron additive in the form of a boron-containing filler.

16. The ceramic composite material of claim 15, wherein the boron-containing filler includes one of B₂O₃, elementary boron, B₄C and BN.

17. A sheathed-element glow plug, comprising:
at least one of an insulating layer and a conductive layer formed by at least partial pyrolysis of one of a starting mixture and a starting body containing a polymer precursor material, wherein the starting mixture or the starting body includes boron in a proportion of 0.1 wt.-% to 60 wt.-%.

18. A method for manufacturing a ceramic composite material, comprising:
providing one of a starting mixture and a starting body containing a polymer precursor material, wherein that starting mixture or the starting body includes boron in a proportion of 0.1 wt.-% to 60 wt.-%; and
performing at least partial pyrolysis of the one of the starting mixture and the starting body.
